(19) United States
(12) Patent Application Publication
(10) Pub. No.: US 2024/0056781 A1
(43) Pub. Date: Feb. 15, 2024

(54) REAL-TIME PLANT HEALTH SENSOR SYSTEM

(71) Applicant: C. Bruce BANTER, Northville, MI (US)

(72) Inventor: C. Bruce BANTER, Northville, MI (US)

(21) Appl. No.: 18/219,947

(22) Filed: Jul. 10, 2023

Related U.S. Application Data
(63) Continuation-in-part of application No. 63/407,642, filed on Sep. 17, 2022.
Application No. 63/407,642 is a continuation-in-part of application No. 63/397,093, filed on Aug. 11, 2022, now abandoned.

(51) Int. Cl. H04W 4/38; H04W 84/18

(52) U.S. Cl. CPC H04W 4/38; H04W 84/18

(57) ABSTRACT

A wireless plant sensor system transmits data in real time via a cloud. The system comprises a child sensor digitally and wirelessly connected to a parent sensor, the parent sensor relaying plant sensor data to the cloud central processing unit, and a user interface that is digitally connected to the cloud. The sensor processing unit provides control and management of system power via a power regulator circuit, which is electrically engaged to power harvesting components, which include a solar cell, a rf energy harvester, a rf antenna and rechargeable energy storage components. The input components to the sensor processing unit include; an accelerometer, temperature and humidity sensor, and an analog front end/LED driver that controls a plurality of LED light guides and emitters. The power regulator circuit regulates power flow from a solar cell and a rf energy harvester to a rechargeable power source.

### CROSS-REFERENCE TO RELATED APPLICATIONS

This Application is a Continuation-in-Part and claims priority to U.S. patent application Ser. No. 18/201,541, entitled “REAL TIME PLANT HEALTH SENSOR SYSTEM” (Banter), filed May 24^{th}, 2023; U.S. patent application Ser. No. 18/109,504, entitled “REAL TIME PLANT HEALTH SENSOR SYSTEM” (Banter), filed February 14^{th}, 2023; U.S. Provisional Application No. 63/407,642, entitled “WIRELESS MESH CROP SENSING NETWORK” (Banter), filed on September 07^{th}, 2022; and U.S. Provisional Application No. 63/397,093, entitled “WIRELESS MESH CROP SENSING NETWORK” (Banter), filed on August 11^{th}, 2022.

### BACKGROUND OF THE INVENTION

### Field of the Invention

This invention relates to a wireless sensor system for real time monitoring and controlling plant health.

### Background Information

Plants are grown in outside environments or sheltered enclosures with controlled light exposure, moisture, and nutrients.

Plants, like humans, are sensitive to extreme heat. When temperatures soar, plants wither, and their health deteriorate. The ability of plants to grow is affected and their life cycles are shortened. Ultimately, plant yields are reduced with consequences for food supply and agriculture, an important sector of the economies of many countries including the US, Europe, Asia, Australia, South America, and many African countries.

Severe heat can damage plants due to potential dehydration or hyperthermia, heat cramps, heat expansion, and heat stroke. Dried soils are more susceptible to erosion, decreasing the land available for agriculture. The outbreaks of wildfires become more frequent as dry plants increase the likeliness of igniting. The evaporation of bodies of water compounds the problems, decreasing the size of the habitats available as well as the amount of nutrition present within the waters.

Heat waves increase the risk of plant failures, threatening food security for billions of people. Scientists around the world have generated evidence of the plant and yield losses associated with heat waves and extreme temperatures. Plant failures and productivity losses due to excessive heat, drought and flooding are occurring now globally.

All plants require the essential elements of sunlight, water, and nutrients to flourish. Farmers and growers must monitor and manage the amounts of the essential elements that the plants receive for healthy growth. Additional factors that affect plant health are physical damage from wind, rain, hail, animals, birds, and humans. Exterior plants are subject to natural events while interior plants have the essential elements more controlled.

The time frame to manage vegetation and plants varies by the type of plant. Some plants require years before the plant bears fruit, but all plants require management to achieve optimum health, growth, and yield.

The management of plants requires constant data about the conditions. Data collection is currently limited to visual inspections and general information on large portions of the plant and fields or only limited areas of the field with expensive sensors. Weather data for the local region can provide general information on the ambient temperature, rain received, humidity, and sunlight. Rain gauges and temperature devices can be used to provide more specific data on areas of the field or plant, but the data is only a portion of the needed information.

Agriculturists still need to physically walk the fields to visually inspect the plant conditions and damage for real-time information. The data needed to manage plant health and yields is not available to agriculturists in any consolidated or easy-to-use method. Time and resources are required to collect and analyze the available data from a multitude of sources.

The prior art discloses the following:
U.S. Ser. No. 17/445,928 (Guan et al.) discloses an integrated multi-scale modeling platform that is utilized to assess agricultural productivity and sustainability. The model is used to assess the environmental impacts of agricultural management from individual fields to watershed/basin to continental scales. In addition, an integrated irrigation system is developed using data and a machine-learning model that includes weather forecast and soil moisture simulation to determine an irrigation amount for farmers. Next, plant cover classification prediction can be established for an ongoing growing system using machine learning or statistical model to predict the planted plant type in an area. Finally, a method of predicting key phenology dates of plants for individual field parcels, farms, or parts of a field parcel, in a growing season, can be established.
U.S. Ser. No. 17/415,598 (Guan et al.) discloses an apparatus and method for plant yield prediction. The processing system includes a processor; and a memory that stores executable instructions that, when executed by the processing system, perform operations, the operations comprising: identifying an occurrence of one or multiple phenology stages of a plant, resulting in identified occurrences; optimizing, based upon the identified occurrences, a yield model, wherein the yield model produces, after the optimizing, a first predicted yield for a first region; and generating a second predicted yield based upon the first predicted yield, wherein the second predicted yield covers a second region that is smaller than the first region. Additional embodiments are disclosed.
U.S. patent Ser. No. 10/009,783 (Baroudi; et al.) discloses an energy efficient data collection routing protocol for wireless rechargeable sensor networks. The system and method of determining a data collection routing protocol include the steps of perceiving a broadcast beacon message from an i^{-th} sensor node located at an i^{-th} sensor level by one or more sensor nodes at one or more other sensor levels of a divided WSN, wherein the i^{-th} sensor level does not include a first sensor level of a sink sensor node; resetting the respective sensor level of the one or more sensor nodes to an (i+1)^{th} sensor level; attempting to connect the i^{-th} sensor node at the i^{-th} sensor level to another sensor node located at an (i−1)^{th} sensor level; and connecting the i−^{th} sensor node to a parent sensor node at the i^{-th} sensor level when certain conditions are met. These conditions are determined and analyzed locally at each sensor node.
U.S. Pat. No. 9,148,849 (Akhlaq; et al) discloses a coverage, connectivity, and communication protocol method for wireless sensor networks. The coverage, connectivity and communication protocol method is an integrated and energy-efficient protocol for the coverage, connectivity and communication in wireless sensor networks. The coverage, connectivity and communication protocol use a received signal strength indicator to divide the network into virtual rings, defines clusters with cluster heads more probably at alternating rings, defines dings, which are rings inside a cluster, uses triangular tessellation to identify redundant nodes, and communicates data to sink through cluster heads and gateways. The protocol strives for near-optimal deployment, load balancing, and energy-efficient communication. Simulation results show that the coverage, connectivity, and communication protocol ensure partial coverage of more than 90% of the total deployment area, ensures 1-connected network, and facilitates energy-efficient communication, while expending only one-fourth of the energy compared to other related protocols.
U.S. Pat. No. 7,835,885 (Ben-Tzur et all) discloses A system for monitoring parameters of produce including at least one sensor assembly for sensing at least one parameter of packaged produce at a plurality of times and locations of the packaged produce; a communications network operative to receive information from the at least one sensor assembly at the plurality of times and locations and to transmit the information to at least one information receiving location; and at least one computer at the at least one information receiving location for receiving the information transmitted via the communications network and for providing an information output put representing the at least one parameter at the plurality of times.

These methods are focused on large scale areas for plant management or the post-harvested quality of produce.

A cost-effective method is needed to provide agriculturists with consolidated, cost-efficient, prediction information, and real-time information on the current conditions of the plants in their fields. This information can also be provided for the models and systems described in the previously mentioned Patents/Applications for macro management of large-scale agricultural areas.

What is needed is a plant sensor system that uses available general location information for predicting and forecasting impacts to plant growth and health that can be combined with actual local plant level real-time data.

Local weather conditions and forecasts provide valuable information that can be utilized to predict water, sunlight heat, and wind effect on the grow of the plant. This information can be conveniently presented to users to assist management of the plant such as increasing irrigation, adding nutrients or adding wind screens. Interior plants management can also adjust light energy and temperature to the field. The predictions and forecasts are analyzed with the actual plant level data to confirm and adjust actions.

The health of plants in areas of a field can be derived or extrapolated from satellite and drone imagery or from sensors in the field at the plant level. Many expensive sensors are required to cover a large portion of a field. Current sensors that have been deployed in fields have been expensive and provide only one or two of the needed types of information.

A sensor system that provides local plant level data needs to be created by sensors that can withstand the environmental conditions for deployment for the entire growth and harvest cycle as well as future deployments and not require maintenance or replacement.

The data output of the plant sensors needs to be available to the agriculturist in real time and the plant sensors must be able to transmit the relevant information to a convenient user interface for presentation to the agriculturist.

The plant sensor system must have a price point that is low enough for the user to achieve a return on investment. The cost to create the information must be less than the benefit derived from the improved management.

The plant sensors must be self-powered and not require frequent replacement of the power sources since providing power to plant sensors in the field is not cost effective. The plant sensors need to be small sized such that do they do not impact the health or the growth of the individual plants. The location of the individual sensors needs to be able to be adjustable with the growth of the plant and maintain close contact with the plant or harvest product.

The plant sensors need to be easily retrieved from the field before the plants are harvested, if the plant structure of the plant is cleared from the field at harvesting; for example-corn, wheat, or soybeans. Alternatively, the sensors can remain on the plants of orchards and bush types of plants to continue management of the plants after harvest.

The objective of the plant sensor system of the present invention is to generate a low cost, robust, easy to use system that provides real-time information on the present conditions of the plant and field and highlights areas that need attention.

### SUMMARY OF THE INVENTION

The plant sensor system of the present invention addresses these needs and objectives.

An “agriculturist” as used herein is a person or organization in the science, practice, and management of agriculture. The primary role of an agriculturist is in leading agricultural projects and programs, usually in agribusiness planning or research for the benefit of farms, food, and agribusiness related organizations.

The plant sensor system of the present invention describes a cost-effective method and devices that provide real-time information on temperature, humidity, sunlight, shock, and health of individual plants or areas of the field and the aggregation of the individual data to understand the condition of the entire monitored area.

The plant sensor system of the present invention monitors the health of plants in a plant cluster.

The plant sensor system comprises a first plant child sensor and a second plant child sensor in the plant cluster and a processing unit.

The first plant child sensor transmits data about a first plant in the plant cluster by a first plant child sensor to a cloud via a plant parent sensor. The second plant child sensor transmits data about a second plant in the plant cluster to the cloud via either the same or a different plant parent sensor.

In order to obtain the best profile of plant data of the plant cluster, preferably the first plant child sensor is a temperature sensor, and the second plant child sensor senses a vegetative property in addition to temperature.

The first plant child sensor is affixed to the first plant in the plant cluster and measures a first vegetation property of the first plant in the plant cluster. The data from the first plant child sensor is transmitted via a plant parent sensor to the cloud.

The second plant child sensor is affixed to the second plant in the plant cluster and measures a second vegetation property. The data from the second plant child sensor is transmitted via a plant parent sensor to the cloud.

Accordingly, in addition to temperature at least one of the plant sensors preferably provides data about humidity, sunlight, shock, light energy, vibration, NIR, RED, GREEN, wavelengths, vegetation indexes, and health of an individual plant in the plant cluster.

The display enables presentation of data to an agriculturist comparing the first plant child sensor data with historical plant data for plants with similar genome in the plant cluster and a stage of development of the first plant in the plant cluster to determine ongoing deviations from expected results in real time. The display also enables presentation of data to the agriculturist comparing the second plant child sensor data with historical plant data for plants with similar genome in the plant cluster and a stage of development of the second plant in the plant cluster to determine ongoing deviations from expected results in real time.

The plant child and parent sensors preferably include a temperature and humidity sensor, and an analog front end/LED driver. The analog front end/LED driver controls a plurality of LED light guides and emitters of different wavelengths and a plurality of light guides and receivers.

The plant sensor system comprises a child sensor wirelessly and digitally connected to a parent sensor for the transmission of data. There are two types of wireless networks that can be utilized to connect the sensors and relay the data to the cloud. The wireless mesh network comprises of plant child sensors and plant parent sensors.

The parent sensor is also wirelessly and digitally connected to a microprocessor and a user interface. The parent sensor includes a cellular connection and GPS location. The parent sensor relay plant sensor data to the cloud.

The microprocessor controls the operation of the other components and processes the input information and outputs the information for transmission. The input components to the microprocessor are an accelerometer, temperature and humidity sensor, and an analog front end/LED driver that controls three LED light guides and emitters of different wavelengths and two light guides and receivers. The output of the processed data from microprocessor is sent to the rf short range transceiver and rf antenna and to the cellular modem and cellular antenna that are in the parent sensors or the gateways. The microprocessor also provides control and management of the system power by a power regulator circuit which is connected to power harvesting components—solar cell, rf energy harvester, and rf antenna plus rechargeable energy storage components. A separate rf energy transmitter is placed in proximity to the mesh network to transmit rf energy to the mesh network and the parent and plant child sensors.

The microprocessor also controls the retrieval sounder and the retrieval LED for the location and retrieval of the child and parent sensors before harvesting.

The user interface and presentation of the data is contained and displayed either on a stationery device or a mobile device which includes an APP that is digitally connected to the cloud.

For a complete understanding of the wireless plant health sensing system of the present invention, reference is made to the following detailed description and accompanying drawings in which the presently preferred embodiments of the invention are shown by way of example. As the invention may be embodied in many forms without departing from the spirit or essential characteristics thereof, it is expressly understood that the drawings are for purposes of illustration and description only and are not intended as a definition of the limits of the invention.

### BRIEF DESCRIPTION OF THE DRAWINGS

FIG. 1 depicts a first preferred embodiment of the plant sensor system of the present invention, a wireless mesh network plant sensor system.

FIG. 2A depicts a functional diagram of a plant child sensor for use with the plant sensor system of FIG. 1.

FIG. 2B depicts a functional diagram of a plant parent sensor for use with the plant sensor system of FIG. 1.

FIG. 3A depicts a preferred embodiment of an assembly view of the plant child sensor for use with the plant sensor system FIG. 1, including a microprocessor, temperature and humidity sensor, accelerometer, an analog front end/LED driver, three light guides and emitters, an rf transceiver, two light guides and receivers, retrieval sounder, retrieval LED, solar cell, rf energy harvester, and a rechargeable power supply all mounted relative to a printed circuit board and encapsulated, the plant child sensor including a strap for ease of mounting relative to the produce.

FIG. 3B depicts the front view of the plant child sensor of FIG. 3A.

FIG. 4A depicts a first preferred embodiment of an assembly view of the plant parent sensor for use with the wireless mesh network plant sensor system of FIG. 1, including a microprocessor, temperature and humidity sensor, accelerometer, an analog front end/LED driver, three light guides and emitters, an rf transceiver, two light guides and receivers, retrieval sounder, retrieval LED, solar cell, rf energy harvester, cellular modem, cellular antenna, eSIM, and a rechargeable power supply all mounted relative to a printed circuit board and encapsulated, the plant parent sensor including a strap for ease of mounting relative to the produce. FIG. 4B depicts the end view of the plant parent sensor of FIG. 4A.

FIG. 5 depicts a chart of “The Vegetation Spectrum” plotting the “Apparent Reflectance” vs. “Wavelength” through the visible wavelength, near-infrared wavelength, and shortwave infrared wavelength for use with the wireless plant sensing system of FIG. 1.

FIG. 6 depicts an rf energy broadcast from an rf energy transmitter for the mesh network of the plant sensing system of FIG. 1.

FIGS. 7A, 7B, 7C, 7D, 7E, and 7F depict the six stages of a potted plant from sprout to ripening and the various nutrients needed for healthy plant growth in each stage.

FIGS. 8A and 8B depict a simplified function flow diagram of the mesh network plant sensing system of the present invention (preferred embodiment).

FIG. 9 depicts a “Plant Sensor System Database, and Processing” a “Local Weather Database” and a “System Database for Each Sensor” and a “Comparison of Databases” facillitating access to system data on a display.

### DETAILED DESCRIPTION OF THE PREFERRED EMBODIMENTS OF THE INVENTION

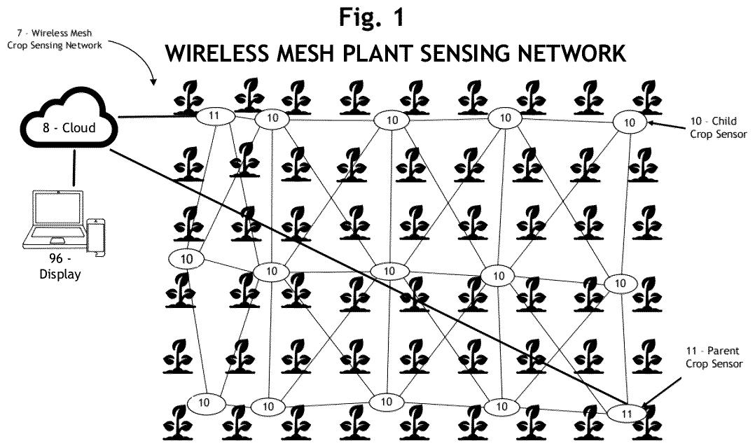

Referring now to the drawings, FIG. 1 depicts the preferred embodiment of real-time plant health sensor system of the present invention [7].

The plant sensor system of the present invention is a wireless mesh network plant sensor system [7]. The plant sensor system of the present invention [7] comprises one or more individual plant child sensors [10] and one or more individual plant parent sensors [11] located around the monitored area that are wirelessly linked to each other for the communication of information. The data from the sensors is communicated to a central location in the cloud [8] where the data is aggregated with other information relevant to the health and management of the plant. The sensors form a mesh network which connects the sensors to adjacent sensors. The wireless mesh network includes plant child sensors [10] and plant parent sensors [11]. The plant child sensors [10] are the majority and simplest sensors that only communicate via short range wireless to each other and to more complex plant parent sensors [11]. The plant parent sensors [11] do the same function as the plant child sensors [10] plus relay the data via a cellular connection to the cloud [8]. The individual sensor data is relayed through the mesh network via the lowest cost and fastest path to a plant parent sensor [11] and subsequently to the cloud [8].

The plant parent sensors [11] are more costly, so the number of plant parent sensors [11] are minimized to provide the lowest cost option to achieve connection of the mesh network to the cloud [8] and provide at least one backup connection. The distance between the individual sensors must be within the transmission range of the wireless transmitters. High level processing and analysis is done in the cloud [8] and the plant parent sensor [11] needs to have a cellular connection to transmit the data. The user interface and presentation of the data is either displayed on a display [96] which is either a stationery device or a mobile device which has the APP and is digitally engaged with the cloud and central processing [8].

The plant sensor system of the present invention [7] monitors the health of plants in a plant cluster.

The plant sensor system [7] comprises a first plant child sensor [10] and a second plant child sensor [10] in the plant cluster, cloud central processing [8], and user display [96].

The first plant child sensor transmits data about a first plant in the plant cluster by a first plant child sensor [10] to a cloud central processing [8] via a plant parent sensor [11]. The second plant child sensor [10] transmits data about a second plant in the plant cluster to the cloud central processing [8] via either the same or a different plant parent sensor [11].

In order to obtain the best profile of plant data of the plant cluster, preferably the first plant child sensor [10] is a temperature sensor, and the second plant child sensor [10] senses a vegetative property in addition to temperature.

The first plant child sensor is affixed to the first plant in the plant cluster and measures a first vegetation property of the first plant in the plant cluster. The data from the first plant child sensor [10] is transmitted via a plant parent sensor [11] to the cloud central processing [8].

The second plant child sensor [10] is affixed to the second plant in the plant cluster and measures a second vegetation property. The data from the second plant child sensor [10] is transmitted via a plant parent sensor [11] to the cloud central processing [8].

Accordingly, in addition to temperature at least one of the plant sensors preferably provides data about humidity, sunlight, shock, light energy, vibration, NIR, RED, GREEN, wavelengths, vegetation indexes, and health of an individual plant in the plant cluster.

The cloud central processing unit [8] enables presentation of data via the user Display [96] to an agriculturist comparing the first plant child sensor data with historical plant data for plants with similar genome in the plant cluster and a stage of development of the first plant in the plant cluster to determine ongoing deviations from expected results in real time. The cloud central processing unit [8] also enables presentation of data to the agriculturist comparing the second plant child sensor data with historical plant data for plants with similar genome in the plant cluster and a stage of development of the second plant in the plant cluster to determine ongoing deviations from expected results in real time.

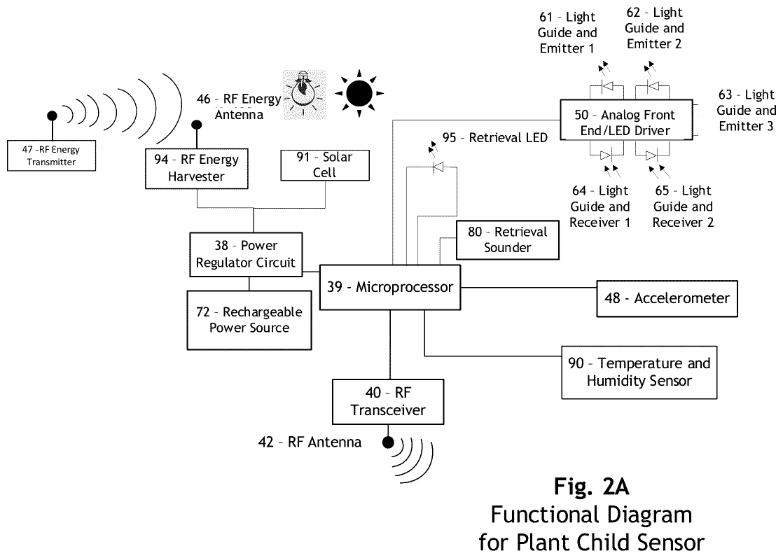

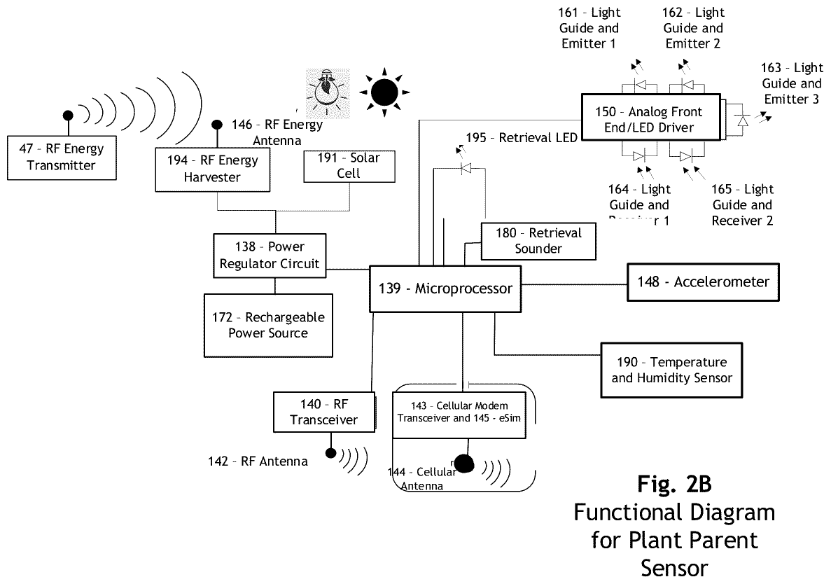

FIG. 2A depicts a functional diagram of the preferred embodiment of the plant child sensor [10] for the wireless mesh plant sensing network of the present invention [7]. The sensor system comprises a microprocessor [39] that controls the operation of the other components and processes the input information and outputs the information for transmission. The components connected to the microprocessor [39] are an accelerometer [48], a temperature and humidity sensor [90], a retrieval sounder [80], a retrieval LED [98], and an analog front end/LED driver [50] that controls three LED light guides and emitters [61, 62, and 63] of different wavelengths and two light guides and receivers [64, and 65].

The output of the processed data from the microprocessor [39] is sent to the rf short range transceiver [40] and the rf antenna [42]. The microprocessor [39] also provides control and management of the system power by a power regulator circuit [38] which is connected to power harvesting components—a solar cell [91], a rf energy harvester [94] and an rf energy antenna [46] plus an rechargeable energy storage components [72]. A separate rf energy transmitter [47] is placed in proximity to the mesh network to transmit rf energy to the mesh network and the plant child sensors [10] and the plant parent sensors [11]. The solar cell [91] collects energy from the sun or the plant light source in internal applications.

The accelerometer [48] measures the impact force, vibrant and the three-axis orientation of the sensor. The accelerometer [48] is a very low power device that is used to wake up the other components when a desired level of force is measured. The other devices can be either awake or in a low power mode on a time base schedule to minimize power usage but still provide measurements and communication of data. The accelerometer's force measurements can detect when impact or force has been applied to the plant. The amount of force and the frequency can be compared to wind data and other environmental information to understand the effect to the plant from wind, rain, hail, or snow. Impact forces can be measured from animal or human contacts to determine the effect to the plant. Alerts are sent to the user interface when high forces are recorded in specific areas. The force data can be used by the agriculturist to target suspect areas of the field and focus attention on those areas.

The temperature and humidity sensor [90] is a sensor that packages temperature and humidity measurements into a small efficient package that shares communication and power elements. The new combination sensors are low enough in cost and size to be more effective than single function sensors. The temperature and humidity information are determined at the plant level and is more accurate than temperature and humidity data for general areas of the field or weather data for the local geographic area. Specific plants can experience conditions very different from the larger area because of various factors. Information on the specific plant enables better management of the health of that plant.

Humidity sensing requires that the sensor has access to the air around the plant. An air access port or vent [92] is provided in the sensor enclosure to enable air to be channeled to the humidity sensor [90]. A humidity mesh patch [93] in the air access path enables the air with moisture to penetrate the air access channel and to the humidity sensor [90] but stops water from entering the sensor enclosure. The humidity directly around the plant is a valuable indication of the favorable conditions for the plant and if additional moisture is required.

The light guide and receiver [65] provides measurement of the ambient light received at the plant. The light guide transmits the light energy from the outward facing side of the sensor into the sensor enclosure and to the conveniently located receiver component. The energy data from the receiver is transmitted to the analog front end/LED driver [50] which provides a conversion of analog to digital information and communication to the microprocessor [39]. The ambient light information at the plant and sensor area provides a more accurate picture of the light energy received by the plant. The amount of received light energy is also an indication that snow or dirt is covering the sensor and the plant.

The light guide portion of the light guide and receiver 2 [65] also channels the light from the retrieval LED [95] to the outside of the bottom sensor enclosure [13].

The light guide and emitters [61, 62, and 63], and the light guide and receiver 1 [64] provide measurement of light energy of different wavelengths that are sequentially projected into the plant and the energy received back at the sensor. The received energy is compared to expected energy levels for different times and states of growth and health of the specific plant. The analog front end/LED driver [50] sequentially turns on the emitters and receives the energy back via the light guide and receiver [64] for each of the transmitted wavelengths. The emitted energy is either reflected or absorbed by the surface and the underlaying material of the plant. The reflected energy has a shortened path and is received before the absorbed energy. The energy from each wavelength is received back and captured by the receiver [64]. The returned energy is a function of the chemical processes, the water content, and the ethylene in the plant.

The value of returned energy from each wavelength is compared against expected values as to time. The differences between each of the wavelength values are also calculated and used to compare against expected values for plants of similar genome. The comparisons are made to a database of many measurements taken with variables that are known to affect the measurements such as the stage in the growth process, distance from the surface, ambient light, and temperature.

The wireless plant sensing system can be used for different types of plants. When the system is used in plants that the field is cleared at the end of the growth season, then the sensors [10 and 11] need to be located and retrieved prior to harvesting. An alert is sent to the user that the sensors [10 and 11] need to be located and removed from the field before harvesting, a retrieval mode is initiated by the user and system. The sensors [10 and 11] in the field are put into retrieval mode and the user interface displays the specific sensors [10 and 11] on a map of the field. The user interface on a portable device is used to locate the individual sensors [10 and 11] in the field. The location of the portable display [96] is determined in the field by wireless communication with the plant parent sensors [11] and the plant child sensors [10] and the sensors begin retrieval mode. The microprocessor [39] drives the retrieval sounder [80] and retrieval LED [95] at a low frequency pulse for an audible beep and LED visible light flash. The frequency is increased as the portable device is calculated to be closer to the individual sensor. When the user has located the individual sensor, the user interface is manually input to indicate retrieval and all data is sent to the cloud central processing [8] and the shutdown mode is entered.

The retrieval sounder [80] is either a piezo or magnetic device that is mounted to the printed circuit board [20] and driven by the microprocessor [39]. The retrieval LED [95] is a red LED mounted on the printed circuit board [20] and driven by the microprocessor [39]. The light from the red retrieval LED [95] is channeled to the outside of the bottom sensor enclosure [13] by the light guide portion of the light guide and receiver [65].

FIG. 2B depicts a functional diagram of the preferred embodiment of the plant parent sensor [11] for the wireless mesh plant sensing network of the present invention [7]. The sensor system comprises a microprocessor [139] that controls the operation of the other components and processes the input information and outputs the information for transmission. The components connected to the microprocessor [139] are an accelerometer [148], a temperature and humidity sensor [190], a retrieval sounder [180], a retrieval LED [195], and an analog front end/LED driver [150] that controls three LED light guides and emitters [161, 162, and 163] of different wavelengths and two light guides and receivers [164 and 165]. The output of the processed data from the microprocessor [139] is sent to the rf short range transceiver [140] and the rf antenna [142] and to the cellular modem transceiver [143], eSim [145], and Cellular antenna [144] for transmission of data to the cloud central processing [8]. The microprocessor [139] also provides control and management of the system power by a power regulator circuit [138] which is connected to power harvesting components—a solar cell [191], an rf energy harvester [194] and an rf energy antenna [146] plus rechargeable energy storage components [172]. A separate rf energy transmitter [47] is placed in proximity to the mesh network to transmit rf energy to the mesh network and the plant child sensors [10] and the plant parent sensors [11]. The solar cell [191] collects energy from the sun or the plant light source in internal applications.

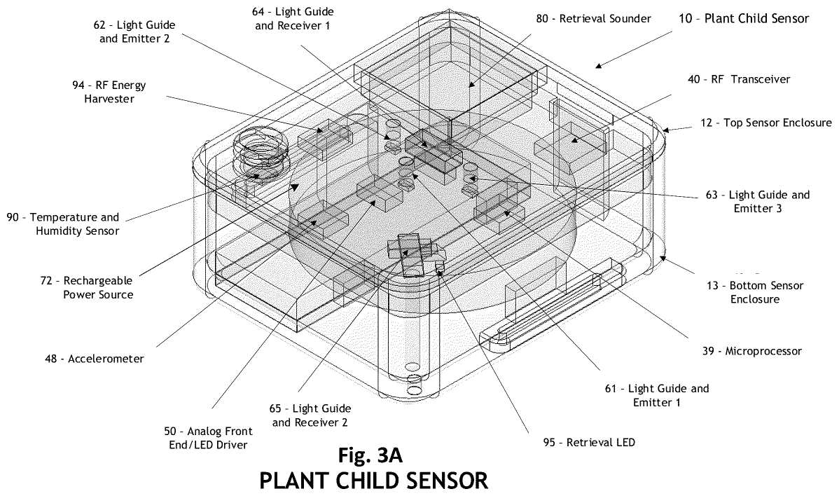

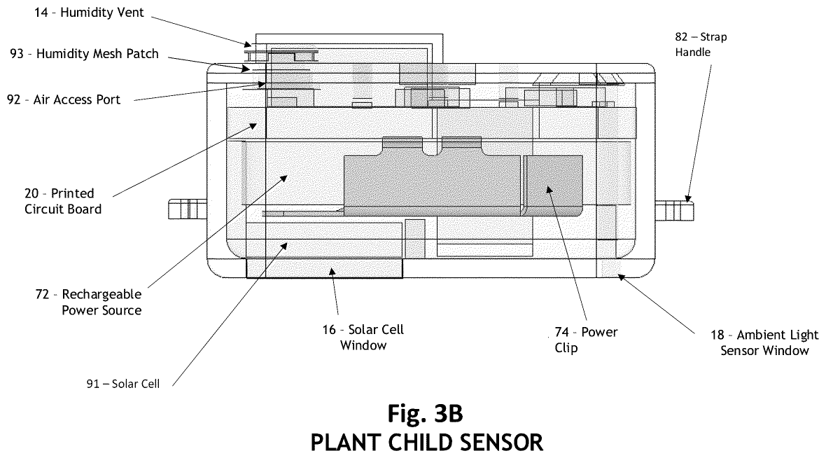

FIGS. 3A and 3B depict assembly views of the preferred embodiment of the plant child sensor [10] for the wireless mesh network plant sensing system [7] in the plant sensor system of the present invention [7]. The plant child sensor [10] includes a microprocessor [39], a temperature and humidity sensor [90], air access port [92], humidity mesh patch [93], and humidity vent [14], an accelerometer [48], an analog front end/LED driver [50], three light guides and emitters [61, 62, and 63], a retrieval sounder [80], a retrieval LED [95], an rf transceiver [40], two light guides and receivers [64 and 65], a power regulator circuit [38], a solar cell [91], an rf energy harvester [94], a power clip [74], and a rechargeable power source [72], all mounted relative to a printed circuit board [20] and encapsulated within a top sensor enclosure [12] with a humidity vent [14] and a bottom sensor enclosure [13] with a solar cell window [16] and an ambient light sensor window [18]. The plant child sensor [10] includes a strap handle [82] for ease of handling. FIG. 3B depicts the front view of the plant child sensor [10] of FIG. 3A.

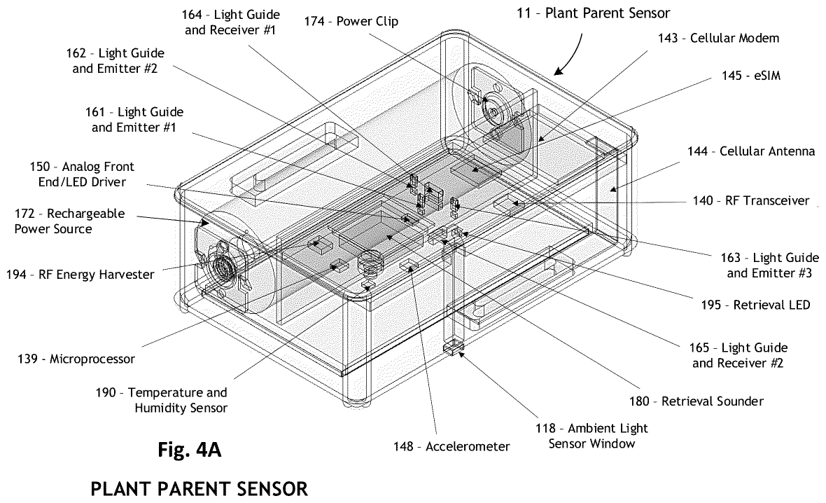

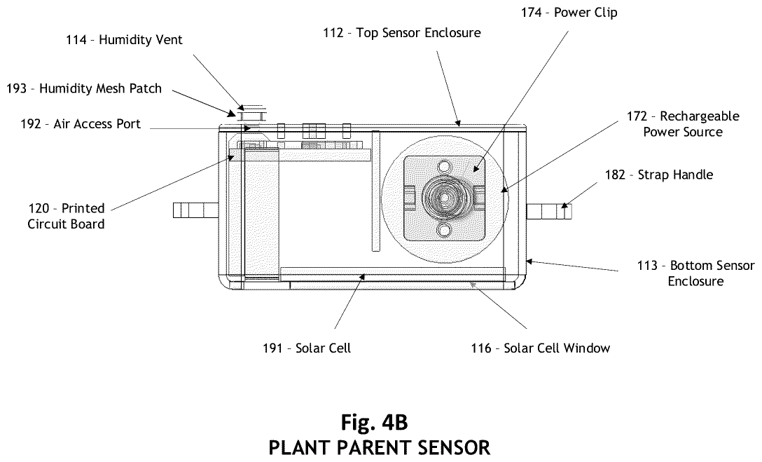

FIGS. 4A and 4B depict a first preferred embodiment of an assembly view of the plant parent sensor [11] for use with the wireless mesh plant sensing network of the present invention [7]. The plant parent sensor [11] includes a microprocessor [139], a temperature and humidity sensor [190], an air access port [192], humidity mesh patch [193], an accelerometer [148], an analog front end/LED driver [150], three light guides and emitters [161, 162, and 163], a retrieval sounder [180], a retrieval LED [195], an rf transceiver [140], two light guides and receivers [164 and 165], a power regulator circuit [138], a solar cell [191], an rf energy harvester [194], a power clip [174], a cellular modem [143], an eSIM [145], a cellular antenna [144], and a rechargeable power source [172] all mounted relative to a printed circuit board [120] and encapsulated within a top sensor enclosure [112] with a humidity vent [114], and a bottom sensor enclosure [113] with a solar cell window [116] and ambient light window [118]. The plant parent sensor [11] includes a strap handle [182] for ease of handling. The retrieval sounder [180] is either a piezo or magnetic device that is mounted to the printed circuit board [120] and driven by the microprocessor [139].

The microprocessor [139] receives the input information from the analog front end/LED driver [150], the accelerometer [148], and the temperature and humidity sensor [190] and processes the information for transmission by the rf transceiver [140] and the rf antenna [142] and the cellular modem [143], cellular antenna [144], and eSIM [145]. The rf transceiver [140] communicates via a wireless mesh network to an adjacent plant child [10] and plant parent sensor [11]. An rf antenna [142] is provided in the traces of the printed circuit board [120] or as a separate antenna component that is mounted on the printed circuit board [120] which are then connected to the rf transceiver [140]. The geometry of the rf antenna [142] and the mating filtering components are tuned to provide optimum transmission and receiving performance with the plant sensor components and enclosure.

A cellular antenna [144] is either a printed circuit board mounted component or a custom metal antenna. The cellular antenna is tuned to the mobile network operator's (MNO) requirements. An eSIM [145] provides the software required to operate on the mobile network operator's network.

Security of the transmitted data and the system is accomplished by encoding the transmitted information and security keys in sensors and devices on the network. The sensors will only respond to authenticated devices on the network creating a private network.

The mesh network enables the transmitted data from one sensor to be relayed to adjacent sensors on the mesh network. The plant child sensors [10] make up most of the network and relay data to plant parent sensors [11] which then relay the information via a cellular connection to the cloud central processing [8]. The plant child sensors [10] communicate the fastest and lowest power path through the network to a plant parent sensor [11].

The plant parent sensors [11] contain a cellular modem transceiver [143], eSIM [145], and cellular antenna [144] which connects to the nearest cellular tower. The cellular antenna [144] can be a stamped metal antenna or a printed circuit board mounted component. The geometry of the cellular antenna [144] and the mating filtering components are tuned to optimize the transceiver performance. The cellular modem [143] requires more power than the mesh network and a larger rechargeable power source [172] and a larger solar cell [191] are required for the plant parent sensors [11] than the plant child sensors [10].

Power management is critical to prolong the operation life of the sensors. The power regulator circuit [138] regulates the power flow from the solar cell [191] and the rf energy harvester [194] to the rechargeable power source [172]. Regulated and constant voltage and current to the sensor components come from the rechargeable power source [172]. The power regulator circuit [138] monitors the voltage and current output from the solar cell [191] and the rf energy harvester [194] and the voltage of the rechargeable power source [172] and controls the current flow into the rechargeable power source [172]. The temperature of the circuit and rechargeable power source [172] are measured and the current controlled to prevent overheating.

The stored power in the rechargeable power source [172] is sufficient to power the sensor for several weeks without any input power from the solar cell [191] or the rf energy harvester [194]. The sensor will send alerts when the internal power is low, and maintenance or attention is required. Low power operation modes are also engaged, and functions are reduced and stopped as the internal power declines.

The solar cell [191] is preferably a monocrystalline type that works well for both external and internal applications. Power from the solar cell [191] is dependent on the ambient sun and light sources. Interior applications benefit from controlled and steady light sources. External applications have varied available light energy with the seasons and weather conditions. Snow, dust, and debris on the sensor will reduce available light energy and requires maintenance to clear the obstruction. The ambient guide and light sensor [165] and the solar cell [191] power output provide indications that the solar cell [191] is being obstructed and an alert is sent for maintenance.

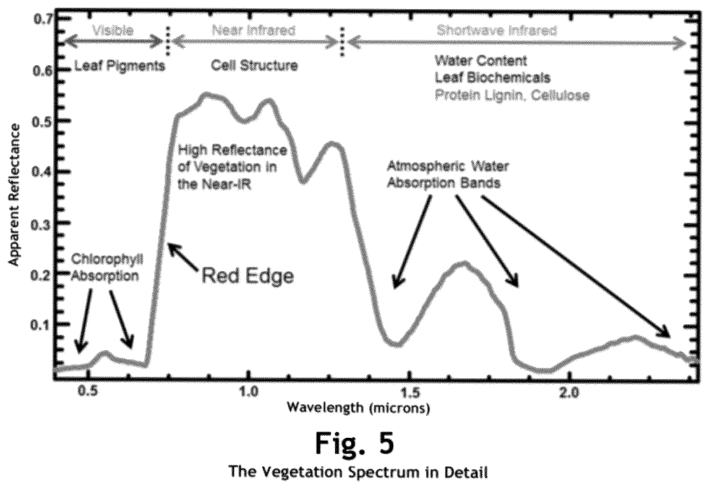

FIG. 5 depicts a chart of “The Vegetation Spectrum” plotting the “Apparent Reflectance” vs. “Wavelength” through the visible wavelength, near-infrared wavelength, and shortwave infrared wavelength for use with the wireless plant sensing system of the plant sensor system of the present invention [7].

The reflected energy from the visible to the near infrared and into the shortwave infrared wavelengths have specific characteristics that can be used to identify the type of plant and chemical compositions. Spectrometers emit energy or light in a wide band of wavelengths and then filter out the return energy at photo receivers except for specific wavelengths to create plots of the responses for the entire band. Several emitting sources are required to produce the entire band of wavelengths as well as many filters and photo receivers to receive the energy. The equipment to create the full spectrum of energy and measurements are lowering in cost and size but they are still well beyond costs and sizes that enable the equipment to be cost efficient systems.

Reflected energy from specific wavelengths are being utilized to determine plant health and characteristics. Normalized difference vegetation indexes such as (NDVI) are a measurement of plant health based on how a plant reflects and absorbs light at specific frequencies typically NIR, red, yellow, and green. Healthy plants reflect a large amount of near infrared (NIR) light, while unhealthy plants absorb more NIR light. Different wavelengths such as green and yellow in addition to IR and red can provide information on the chlorophyll or other chemical processes in the plants. Some of the vegetation indexes were developed to compensate for atmospheric conditions and measurements from satellites.

Unmanned aircraft or drones can be an effective tool for monitoring vegetation, analyzing plant health, and predicting yields. Within minutes, overhead imagery of fields can be collected and analyzed to provide actionable data to the grower. If the imagery is properly used, it can produce significant savings and increased yields for growers. In general, most agriculture drone cameras on the market offer a means to create a plant health index map using the photos that are taken by the camera. Most often, the index being displayed is the normalized difference vegetation index (NDVI) or normalized difference red edge (NDRE). These indices are calculated by comparing the amount of light reflected by the plants in various regions of the light spectrum.

The ability to measure electromagnetic energy at varying wavelengths as it interacts with a material, forms some of the foundation behind remote sensing and spectral science. The physical characteristics of the material cause the electromagnetic energy to be reflected, refracted, or absorbed in a way that is unique to each material. These interactions are measured across discrete sections of the spectrum, that when plotted, form a unique shape that is also known as a material's spectral signature.

Vegetation interacts with solar radiation in a different way than other natural materials. The vegetation spectrum typically absorbs in the red and blue wavelengths, reflects in the green wavelength, strongly reflects in the near infrared (NIR) wavelength, and displays strong absorption features in wavelengths where atmospheric water is present. Different plant materials, water content, pigment, carbon content, nitrogen content, and other properties cause further variation across the spectrum. Measuring these variations and studying their relationship to one another can provide meaningful information about plant health, water content, environmental stress, and other important characteristics. These relationships are often described as vegetation indices (VIs).

Applicable Vegetation Indexes:
Normalized Difference Vegetation Index (NDVI)=(NIR-Red)/(NIR+Red)
Green Chlorophyll Vegetation Index (CGI)=(NIR/Green)−1
Red Edge Vegetation Index (ReCI)=(NIR/Red)−1
Green Normalized Difference Vegetation Index (GNDVI)=(NIR-Green)/(NIR+Green)

The real-time plant health sensor system of the present invention [7] is deployed in close proximity to plants and emit the wavelength energy directly into the plants which provides plant level information verse the large area information from drone and satellite images.

The measurements can also be recorded more frequently and provide real time information.

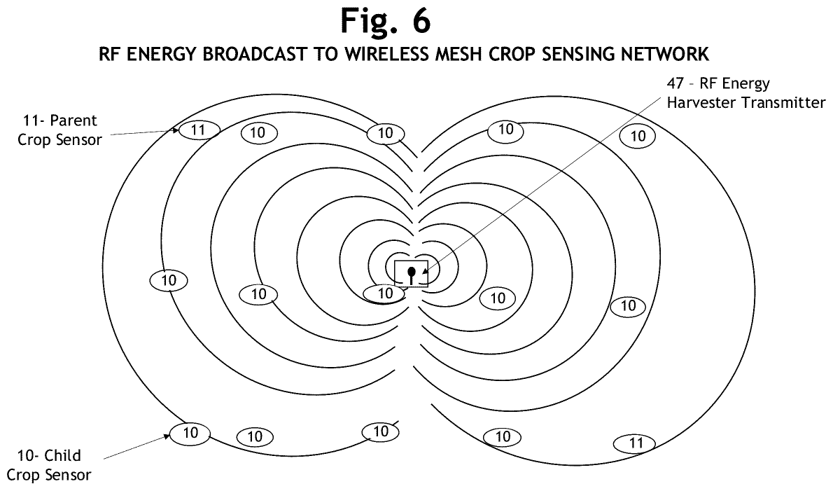

FIG. 6 The rf energy harvesters [94] and [194] within the plant child sensor [10] and the plant parent sensor [11] respectively, receive energy from ambient rf energy or rf energy that is transmitted from an external rf energy transmitter [47]. The rf energy transmitter [47] is placed in proximity to the plant child sensors [10] and the plant parent sensors [11].

The rf energy transmitter [47] receives energy from the power grid or other economical energy source.

The harvested rf energy is relatively low amounts of energy and more costly to generate than the solar energy and serves as a backup or optional. The backup rf energy harvesting provides wireless energy transfer when the solar energy is blocked and not easily cleared. Lower cost sensors can be provided without the rf harvesting optional feature.

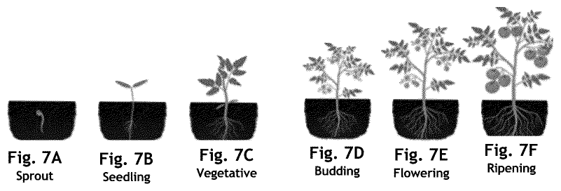

FIGS. 7A through 7F depict the six stages of a potted plant from sprout to ripening and the various nutrients needed for healthy plant growth in each stage.

FIG. 7A depicts the sprout stage. Seed germination and sprouting are the first phases in the life of a plant. Seeds contain all the nutrients needed to start the first phase of the life of the plant. Depending on the type of seed grown, germination and sprouting can take days or several weeks. In this initial plant growth stage, the seed sprouts and grows seed leaves, which look different than the plant's true leaves. It also exhausts its nutrient supply.

FIG. 7B depicts the seedling stage. At the seedling stage, plants develop roots, strong stems and their first true leaves. As roots develop, sprouts grow into seedlings. The plant grows true leaves, which are smaller versions of how mature leaves will look. Nutrients provided at this second phase of plant growth support the plant through stages to come.

FIG. 7C depicts the vegetative stage. During the vegetative stage, plant energies focus on robust green growth in stems, branching and leaves. When seedlings move into the vegetative stage of life, plants focus on developing sturdy stems and green, leafy growth. Nitrogen plays a critical role during this third growth phase.

FIG. 7D depicts the budding stage. In the budding stage, plant energies transition from vegetative growth to flowering mode. As vegetative plants mature, the plants enter a transition phase. Plant energy starts shifting away from green growth toward producing buds, flowers, and eventual fruit. Phosphorus takes on added importance during this fourth stage.

FIG. 7E depicts the flowering stage. The flowering stage sees fruit begin to form where flowers grew. During the flowering stage, buds become flowers and fruiting plants begin forming fruit where flowers grew. At this stage of plant growth, nitrogen becomes less important. Potassium offers significant support for flowering, fruit production and overall plant health.

FIG. 7F depicts the ripening stage. As plants enter the ripening stage, fruit matures and readies for harvest. In this final, sixth stage of plant growth, flowers and fruit ripen and mature. Plants no longer need added nitrogen for leafy growth as plant energy focuses on finishing the flowers and fruits.

The real-time plant health sensor system provides information for all the stages that the plant progresses through. The information assists the agriculturist to manage the growth process and keep the plants health. Current and trending information is provided for specific areas or plants that need attention. Alerts are sent when data meets set point or threshold values. Agriculturists can review historical data and comparisons to expected data for the specific type of plant with similar genome at each stage of development. The data from the agriculturist's field can be aggregated with other data for macro scale reviews, trending evaluations, and geographical area modelling.

Agriculturists can monitor the effects of nutrient additions, water, and sunlight on the plants at each stage. The ambient light is measured at the plant level and compared to the sunlight from local weather data to determine how much energy is getting to the plant. The current NIR, RED, GREEN and vegetation index data compared to expected data from a specific stage of development for plants with similar genome provides the health of the plant and the effects of the water, sun, and nutrients that are getting to the plants. Disease and insect effects can also be predicted by comparison to the historical and expected data.

The sensors may need to be moved as the plants grow to maintain close contact with the areas of the plants to be monitored. The measurements for the NIR, RED, Green and vegetation indexes need the plant child and plant parent sensors to be within close contact with the monitored area of a plant. An alert is sent when the distance is too far for accurate measurements. The other sensor data measurements and communication are continued until the distance is adjusted.

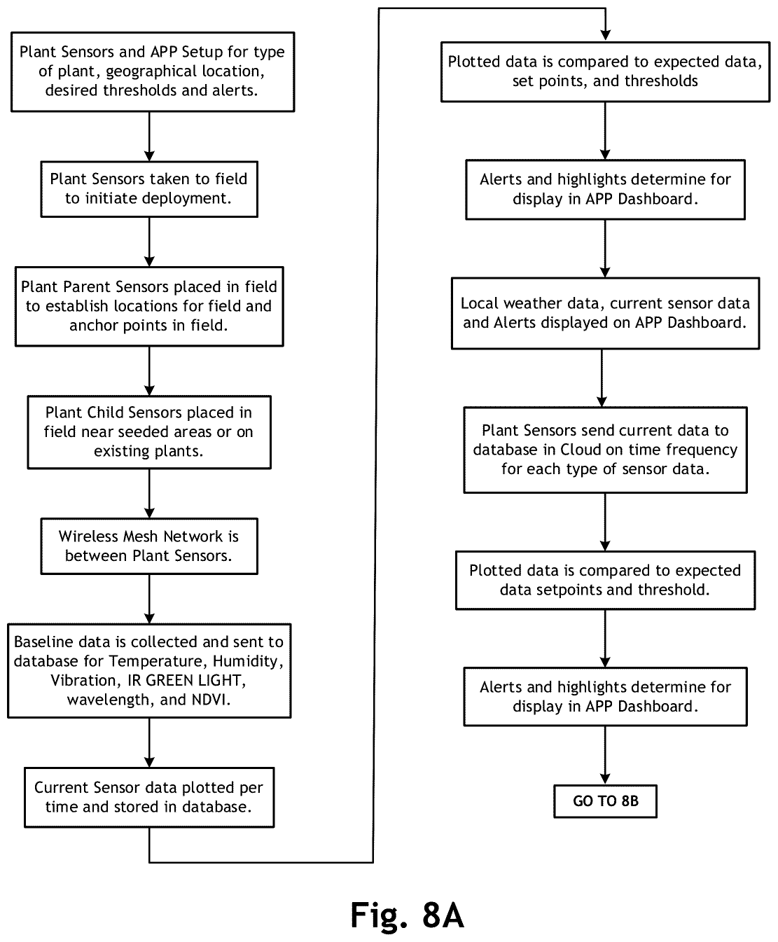

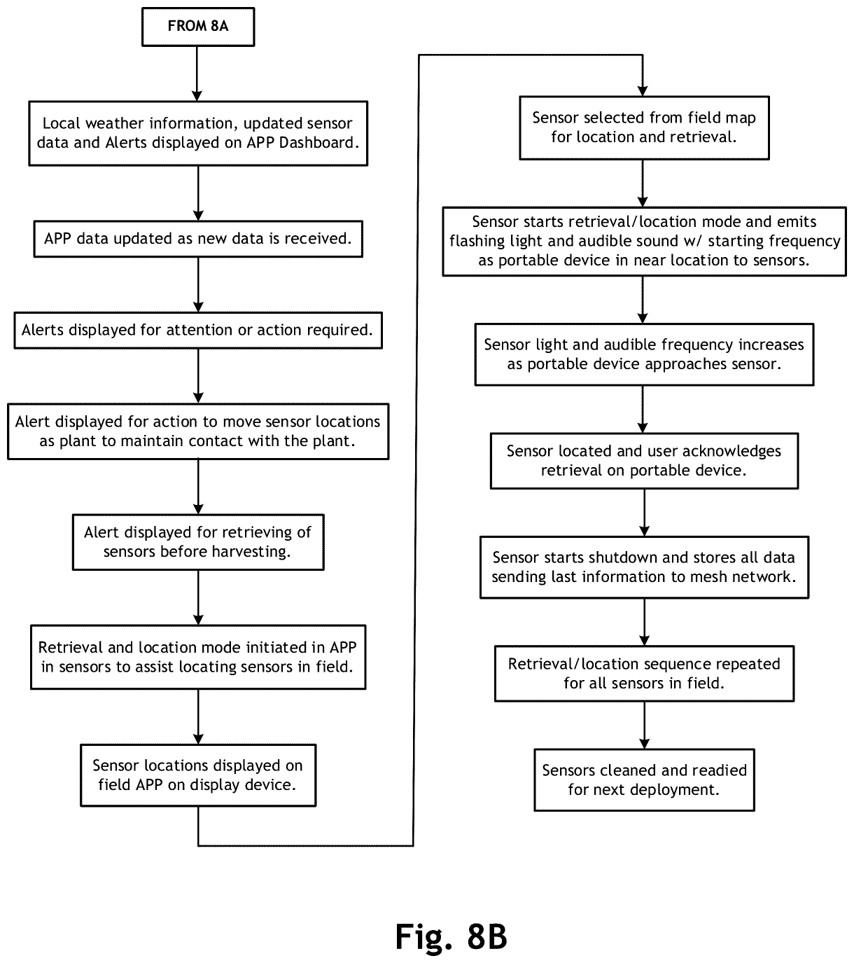

FIGS. 8A and 8B depict a simplified function flow diagram of the preferred embodiment of the mesh network plant sensing system of the present invention [7]

The wireless plant sensor system is easy to install and setup for agriculturists. The plant child sensors [10] and the APP are set up with the type of plant and plant, the location of the field, the stage of the growth process, and any set point and threshold for alerts and attention notices.

The plant child sensors [10] and plant parent sensors [11] are placed around the field. The plant parent sensors [11] are placed first at anchor points to define the field area and establish the location of the field. The plant child sensors [10] are placed around the field either near seeded areas or on existing plants. Deployed plant child sensors [10] and the plant parent sensors [11] create the wireless mesh network and connect to the cloud central processing [8] and APP. The solar cell windows [16] and ambient light sensor windows [18] of plant child sensors [10] and solar cell windows [116] and ambient light sensor windows [118] of plant parent sensors [11] are placed outward from the plants. The optional rf energy transmitter [47] is placed in the center of the field to connect with the sensors around the field.

The sensor information is recorded and sent to the APP per the established time frequency. The received data is compared to expected data and the general weather information for the area. Alerts are determined and sent to the user interface for action.

Alerts are sent during the growing cycle and when the distance between the plant and sensor is determined to be beyond accurate measurement limits.

An alerts is sent before the end of the growing cycle and before harvesting to begin the retrieval process. The retrieval process is conducted with the APP and a mobile display [96]. The sensors [10 and 11] are retrieved, cleaned, and readied for the next deployment.

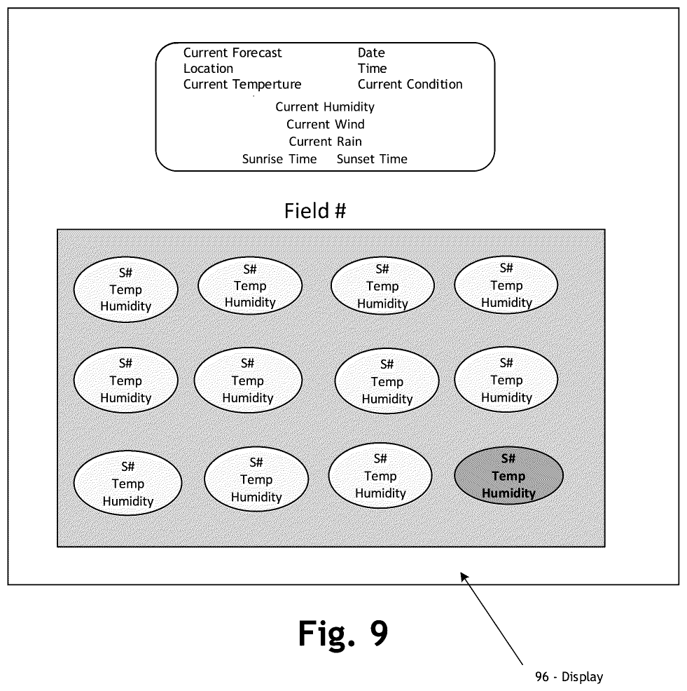

FIG. 9 depicts a “Plant Sensor System Database, and Processing” a “Local Weather Database” and a “System Database for Each Sensor” and a “Comparison of Databases” facillitating access to system data on a display [96] which may be a stationery user interface device or mobile user interface device (not shown).

The continuous sensor data from the field is input into the sensor database for each sensor and the data is plotted verse time. The data is then compared to historical and expected data for plants with similar genome and stage of growth. Alerts are calculated against values for each similar type of plant with similar genome and stage of development. Current data and Alerts are displayed on the User Experience Display for each sensor. Details of the Alerts can be accessed on the User Experience Display by clicking on the Alert for each sensor.

The User Experience Display presents the plant sensor system information to the agriculturists. The Display is interactive and displays current information for the whole system and can present additional information by clicking on an individual sensor. Relevant and useful weather information for the local area is displayed to assist the agriculturists. The temperature and humidity for each sensor is displayed on a grid of the field to show current conditions in each area. Alerts and attention are indicated by highlighting sensors that need attention. The details of the data needing attention is displayed by clicking on the highlighted sensor. After clicking on the highlighted sensor, the display shows the current data and historical plots for temperature, humidity, light energy, vibration, NIR, RED, GREEN, wavelengths, and vegetation indexes for that sensor. Comparisons of expected data to actual can also be displayed for each of the data types by requesting the comparison on the display.

The technology in this Patent Application is similar to the technology disclosed in U.S. Pat. No. 11,408,820 entitled “Produce Freshness Sensor (C. Bruce Banter) filed on Mar. 7, 2022; and the technology disclosed in U.S. Ser. No. 17/830,843 entitled “Wheal and Flare Analyzing System” (C. Bruce Banter) filed on Jun. 2, 2022.

Throughout this application, various Patents and Patent Applications are referenced by number and inventor. The disclosures of these documents in their entireties are hereby incorporated by reference into this specification to more fully describe the state of the art to which this invention pertains.

It is evident that many alternatives, modifications, and variations of the real-time plant health sensor system of the present invention will be apparent to those skilled in the art in lieu of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

7—Wireless Mesh Plant Sensor System
8—Cloud Central Processing
10—Plant Child Sensor
11—Plant Parent Sensor
12—Top Sensor Enclosure
13—Bottom Sensor Enclosure
14—Humidity Vent
16—Solar Cell Window
18—Ambient Light Sensor Window
20—Printed Circuit Board
38—Power Regulator Circuit
39—Microprocessor
40—RF Transceiver
42—RF Antenna
46—RF Energy Antenna
47—RF Energy Harvester Transmitter
48—Accelerometer
50—Analog Front End/LED Driver
61—Light Guide and Emitter #1
62—Light Guide and Emitter #2
63—Light Guide and Emitter #3
64—Light Guide and Receiver #1
65—Light Guide and Receiver #2
72—Rechargeable Power Source
74—Power Clip
80 Retrieval Sounder
82—Strap Handle
90—Temperature and Humidity Sensor
91—Solar Cell
92—Air Access Port
93—Humidity Mesh Patch
94—RF Energy Harvester
95—Retrieval LED
96—Display
112—Top Sensor Enclosure
113—Bottom Sensor Enclosure
114—Humidity Vent
116—Solar Cell Window
118—Ambient Light Window
120—Printed Circuit Board
138—Power Regulator Circuit
139—Microprocessor
140—RF Transceiver
142—RF Antenna
143—Cellular Modem Transceiver
144—Cellular Antenna
145—eSim
146—RF Energy Antenna
148—Accelerometer
150—Analog Front End/LED Driver
161—Light Guide and Emitter #1
162—Light Guide and Emitter #2
163—Light Guide and Emitter #3
164—Light Guide and Receiver #1
165—Light Guide and Receiver #2
172—Rechargeable Power Source
174—Power Clip
180—Retrieval Sounder
182—Strap Handle
190—Temperature and Humidity Sensor
191—Solar Cell
192—Air Access Port
193—Humidity Mesh Patch
194—RF Energy Harvester
195—Retrieval LED

1. A plant sensor system for monitoring health of a first plant in a plant cluster and a second plant in said plant cluster, said plant sensor system comprising:
a first plant child sensor being affixed to said first plant in said plant cluster, said first plant child sensor for measuring a first vegetation property of said first plant in said plant cluster, said first vegetation property being temperature or a property other than temperature of said first plant in said plant cluster, said first plant child sensor transmitting first plant sensor data to a cloud central processing unit via a first plant parent sensor;
a second plant child sensor being affixed to said second plant in said plant cluster, said second plant child sensor for measuring a second vegetation property, other than temperature of said second plant in said plant cluster or a property other than temperature of said first plant in said plant cluster, said second plant child sensor transmitting second plant sensor data to said cloud central processing unit either via said first plant parent sensor or a second plant parent sensor; and
a display unit and said central processing unit enabling presentation of data to a user comparing said first plant sensor data with historical plant data for plants with similar genome to said first plant in said plant cluster and a stage of development of said plant in said plant cluster to determine ongoing deviations from expected results in real time, said plant child sensors and said parent sensors including a processing unit, a temperature sensor, a humidity sensor, and an analog front end/LED driver.

2. The plant sensor system of claim 1, further comprising output of processed data from a processing unit in said plant child sensor or a processing unit in a said parent sensor being sent to an rf short range transceiver, to an rf antenna, and to a cellular modem and cellular antenna, said rf short range transceiver, said an rf antenna, said cellular modem and said cellular antenna being in said plant parent sensor.

3. The plant sensor system of claim 1, wherein said first plant child sensor and said second plant child sensor enable said display unit and said cloud [Cloud] central processing unit to provide comparative data of said first plant and said second plant against historical plant data for plants with similar genome in real time using energy harvesting.

4. The plant sensor system of claim 3 wherein said [power] energy harvesting includes a solar cell, an rf energy harvester, and an rf [re] antenna.

5. The plant sensor system of claim 1, wherein said first plant child sensor measures a first vegetation property other than temperature of said first plant in said plant cluster, said first vegetation property being different from said second vegetation property.

6. The plant sensor system of claim 1, further comprising a first retrieval LED having a first LED visible light flash for said first plant child sensor and a second retrieval LED having a second LED visible light flash for said second plant child sensor, said user interface being on a portable device, said frequency of said first LED visible light flash on said portable device increasing as said portable device approaches said first plant child sensor, said frequency of said second LED visible light flash increasing on said portable device as said portable device approaches said second plant child sensor.

7. The plant sensor system of claim 1, further comprising a first retrieval audible sounding device having a first audible sounding device sound frequency for said first plant child sensor and a second retrieval audible sounding device having a second audible sounding device sound frequency for said second plant child sensor, said user interface being on a portable device, said second audible sounding device sound frequency on said portable device increasing as said portable device approaches said second plant child sensor.

31. The plant sensor system of claim 1, wherein said first vegetation property is a property other than temperature of said first plant in said plant cluster.

32. The plant sensor system of claim 1, wherein said display unit and said central processing unit enable presentation of data to said user comparing said second plant sensor data with historical plant data for plants with similar genome to said second plant in said plant cluster and a stage of development of said second plant in said plant cluster to determine ongoing deviations from expected results in real time.

33. The plant sensor system of claim 1, wherein said analog front end/LED driver controls a plurality of LED light guides and emitters of different wavelengths and a plurality of light guides and receivers.

34. The plant sensor system of claim 31, wherein said display unit and said central processing unit enable presentation of data to said user comparing said second plant sensor data with historical plant data for plants with similar genome to said second plant in said plant cluster and a stage of development of said second plant in said plant cluster to determine ongoing deviations from expected results in real time.

35. The plant sensor system of claim 31, wherein said analog front end/LED driver controls a plurality of LED light guides and emitters of different wavelengths and a plurality of light guides and receivers.

36. The plant sensor system of claim 35, wherein said display unit and said central processing unit enable presentation of data to said user comparing said second plant sensor data with historical plant data for plants with similar genome to said second plant in said plant cluster and a stage of development of said second plant in said plant cluster to determine ongoing deviations from expected results in real time.

37. The plant sensor system of claim 31, further comprising output of processed data from a processing unit in said plant child sensor or a processing unit in a said parent sensor being sent to an rf short range transceiver, to an rf antenna, and to a cellular modem and cellular antenna, said rf short range transceiver, said an rf antenna, said cellular modem and said cellular antenna being in said plant parent sensor.

38. The plant sensor system of claim 31, wherein said first plant child sensor and said second plant child sensor enable said display unit and said cloud central processing unit to provide comparative data of said first plant and said second plant against historical plant data for plants with similar genome in real time using energy harvesting.

39. The plant sensor system of claim 38, wherein said energy harvesting includes a solar cell, an rf energy harvester, and an rf antenna.

40. The plant sensor system of claim 31, further comprising a first retrieval LED having a first LED visible light flash for said first plant child sensor and a second retrieval LED having a second LED visible light flash for said second plant child sensor, said user interface being on a portable device, said frequency of said first LED visible light flash on said portable device increasing as said portable device approaches said first plant child sensor, said frequency of said second LED visible light flash increasing on said portable device as said portable device approaches said second plant child sensor.

41. The plant sensor system of claim 31, further comprising a first retrieval audible sounding device having a first audible sounding device sound frequency for said first plant child sensor and a second retrieval audible sounding device having a second audible sounding device sound frequency for said second plant child sensor, said user interface being on a portable device, said second audible sounding device sound frequency on said portable device increasing as said portable device approaches said second plant child sensor.

42. The plant sensor system of claim 1, wherein said plant sensor system is a wireless mesh network.

43. The plant sensor system of claim 1, wherein said historical plant data is augmented using imagery captured from either a satellite or a drone.

44. The plant sensor system of claim 31, wherein said plant sensor system is a wireless mesh network.

45. The plant sensor system of claim 31, wherein said historical plant data is augmented using imagery captured from either a satellite or a drone.
